(19) United States
(12) Patent Application Publication
(10) Pub. No.: US 2006/0080684 A1
(43) Pub. Date: Apr. 13, 2006

(54) Optical disk device

(76) Inventor: Kyoji Kasuga, Kyoto (JP)

Correspondence Address: EDWARDS & ANGELL, LLP, P.O. BOX 55874, BOSTON, MA, 02205, US

(21) Appl. No.: 11/221,359

(22) Filed: Sep. 6, 2005

(30) Foreign Application Priority Data
Sep. 6, 2004 (JP) 2004-258683

(51) Int. Cl. G11B 33/02

(52) U.S. Cl. 720/600

(57) ABSTRACT

An optical disk device includes a tray in which a cartridge housing a disk is mounted, configured to be transportable to a position where recording and playback are possible by loading the tray into the main body of the optical disk device, and a position where cartridge installation and removal are possible by unloading the tray out of the main body of the optical disk device. In one embodiment of the optical disk device, latching protrusion(s) 24 is/are provided that latch(es) an outer face of an angular portion of the cartridge 30 on the tray 20.

### CROSS REFERENCE TO RELATED APPLICATIONS

This application claims priority under 35 U.S.C. § 119(a) on Patent Application No. 2004-258683 filed in Japan on Sep. 6, 2004, the entire contents of which are hereby incorporated by reference.

### BACKGROUND OF THE INVENTION

1. Field of Invention

The present invention relates to an optical disk device provided with a tray in which a cartridge that houses a disk is mounted.

2. Related Art

Optical disk devices are known in which a cartridge housing a disk is mounted in a tray, and this tray is loaded at a position in the main body of the optical disk device where recording and playback are possible. When this kind of optical disk device is used with a vertical placement such that the tray has a vertical orientation, there are the problems that the cartridge is unstable and drops out from the tray, positional shift between the tray and the cartridge occurs, and the cartridge is jammed between the tray and the main body of the optical disk device. Accordingly, to solve these problems, there have been optical disk devices in which a cartridge having hole portion(s) in the rear face is used, and projection(s) that engage(s) with the hole portion(s) is/are provided in the tray, preventing cartridge instability when the tray is oriented vertically (for example, see Japanese Patent No. 3017723).

Because the conventional optical disk device described above has a configuration in which the projection(s) provided in the tray is/are engaged with the hole portion(s) provided in the cartridge, vertical placement is difficult when the cartridge does not have hole portion(s).

### SUMMARY OF THE INVENTION

It is an object of the present invention to provide an optical disk device which can be used when vertically placed with the tray in a vertical orientation, even with a cartridge that does not have hole portion(s).

The optical disk device of the present invention, includes a tray in which a cartridge housing a disk is mounted, configured to be transportable to a position where recording and playback are possible by loading the tray into the main body of the optical disk device, and a position where it is possible to install and remove the cartridge by unloading the tray out of the main body of the optical disk device, latching protrusion(s) is/are provided in the tray that latch(es) an outer face of an angular portion of the cartridge.

With an optical disk device configured in this manner, because the latching protrusion(s) provided in the tray latch(es) the outer face of the angular portion of the cartridge mounted in the tray, it is possible to hold the cartridge even if the cartridge does not have hole portion(s). Thus, of course when the tray has a horizontal orientation, and even if the tray has a vertical orientation, the optical disk device can be used because there is almost no fear of the cartridge dropping out of the tray, positional shift occurring between the tray and the cartridge, and the cartridge being jammed between the tray and the main body of the optical disk device.

Also, in the above optical disk device, it is preferable that the tray is provided with pressing means that press(es) a mounted cartridge from the front towards a rear wall of the tray, and that the latching protrusion(s) is/are provided in the pressing means and the rear wall. The front of the cartridge means the front of the direction in which the cartridge is inserted into the main body of the optical disk device when loading.

Also, in the above optical disk device, inclined face(s) may be formed in the latching protrusion(s) provided in the rear wall, such that the cartridge can slide when being removed. In such a case, the cartridge can be easily removed, obtaining good operability.

Also, in the above optical disk device, inclined face(s) may be formed in the latching protrusion(s) provided in the pressing means, such that the cartridge can slide when being mounted. In such a case, the cartridge can be easily set, obtaining good operability.

Also, the above optical disk device may be configured so that the inclined face(s) of the latching protrusion(s) provided in the rear wall and the inclined face(s) of the latching protrusion(s) provided in the pressing means do not make contact with the cartridge when the tray is at a position where recording and playback are possible and the disk in the cartridge has been chucked. In such a case, there is almost no front or rear positional shift of the cartridge due to making contact with the inclined faces of the respective latching protrusions, and almost no occurrence of poor chucking. Also, to say that the disk has been chucked means that the disk is held in the state that recording and playback is performed.

Also, in the above optical disk device, when the cartridge has two or more portions of varying thickness, the latching protrusion(s) may be provided in position(s) where the thinner of those portions is latched. In such a case, it becomes possible to make the optical disk device thinner.

### BRIEF DESCRIPTION OF THE DRAWINGS

FIG. 1 is a perspective view of a tray according to an embodiment of the present invention in a state with a cartridge mounted.

FIG. 2 is a perspective view of a tray according to an embodiment of the present invention in a state without a cartridge mounted.

FIG. 3 is a perspective view of the entire optical disk device of the present invention.

FIGS. 4A to 4C show schematic cross-sectional views of the tray shown in FIG. 1 taken along line 4-4, viewed in the direction of the arrow. FIG. 4A is a cross-sectional diagram that shows the cartridge in the midst of loading/removal, FIG. 4B is a cross-sectional diagram that shows a state in which the cartridge is mounted, and FIG. 4C is a cross-sectional diagram that shows a state in which chucking of the disk is complete.

FIGS. 5A and 5B show the cartridge, with FIG. 5A being a plan view and FIG. 5B being a front view.

FIG. 6 is a cross-sectional diagram that corresponds to FIG. 4B, showing another embodiment of the present invention.

FIG. 7 is a cross-sectional diagram that corresponds to FIG. 4B, showing still another embodiment of the present invention.

FIGS. 8A and 8B show still another embodiment of the present invention, with FIG. 8A being a perspective view of a tray corresponding to FIG. 1, and FIG. 8B being a cross-sectional diagram taken along line 8B-8B in FIG. 8A, viewed in the direction of the arrow.

### DESCRIPTION OF THE PREFERRED EMBODIMENTS

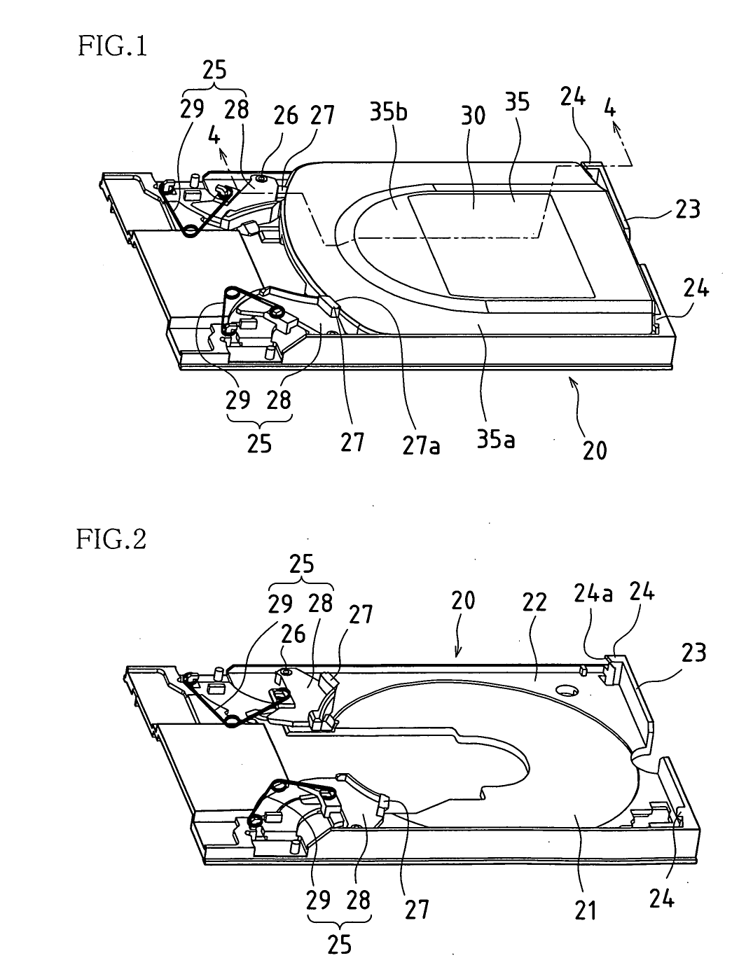

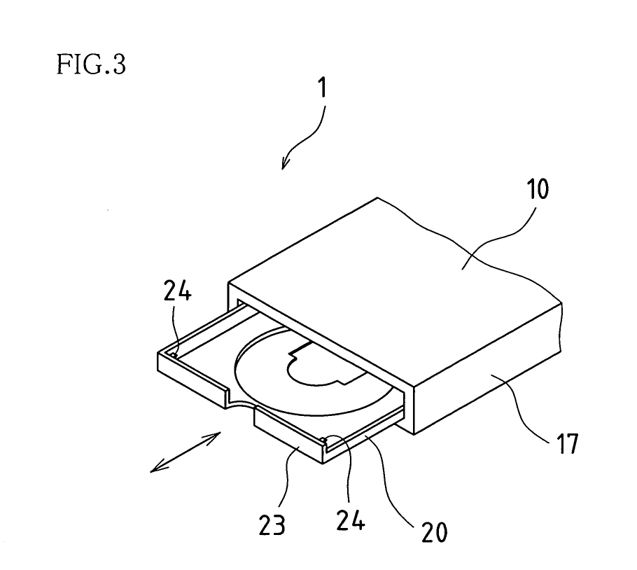

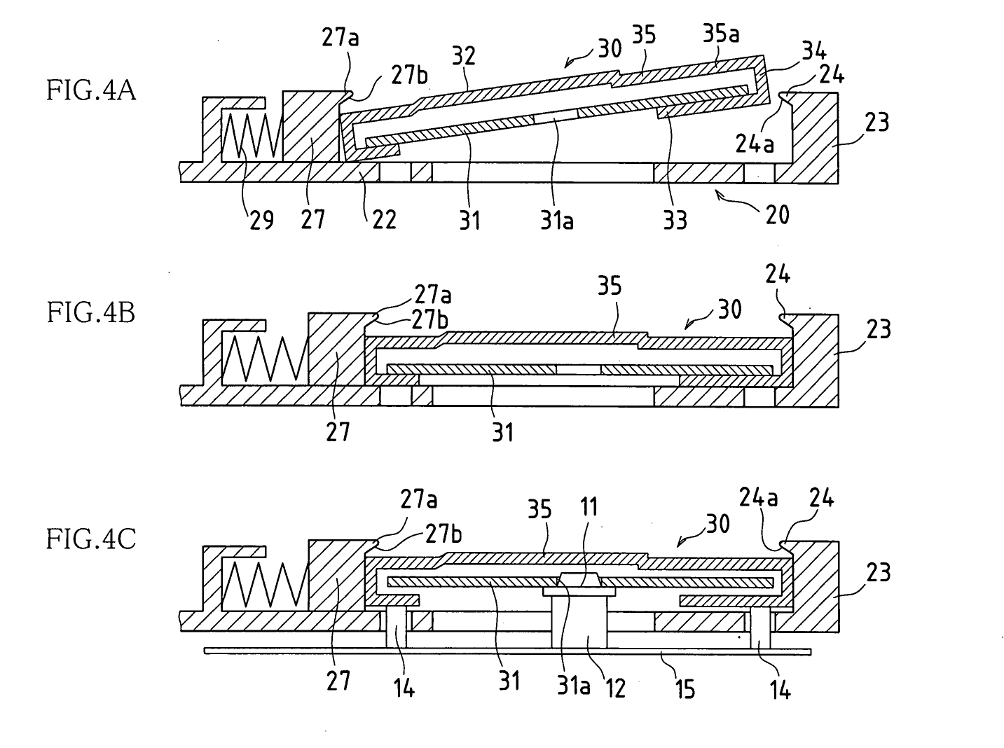

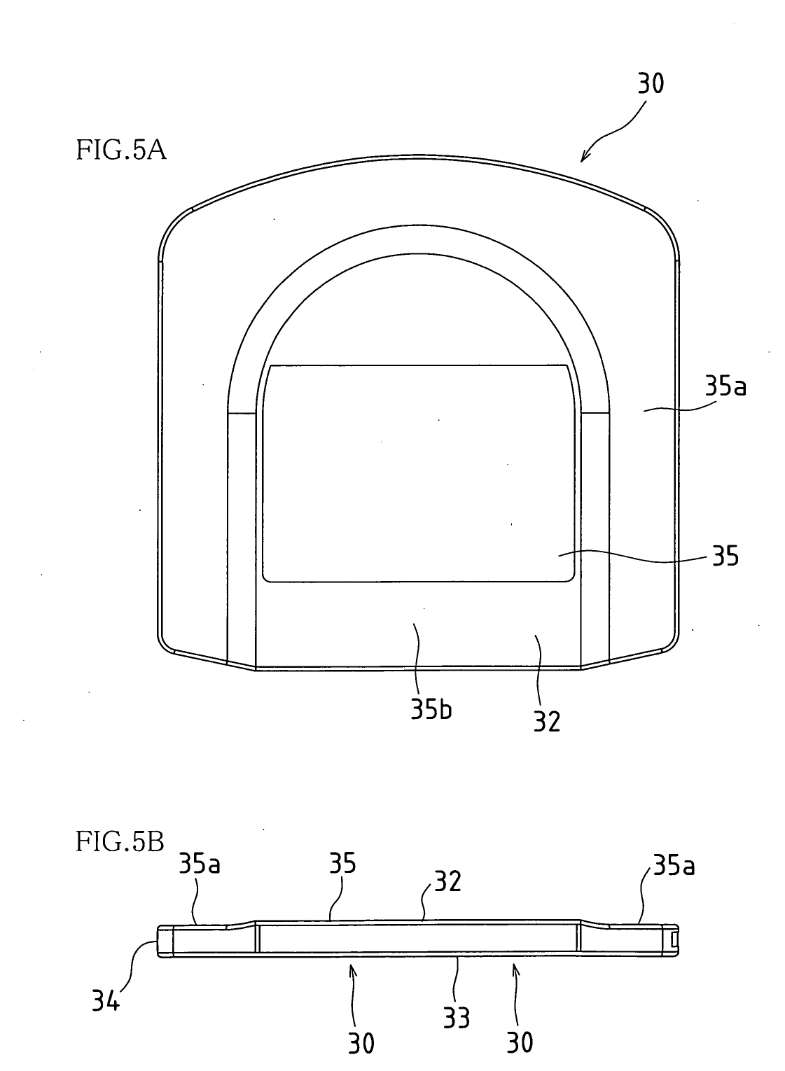

Hereinafter, an embodiment of an optical disk device according to the present invention will be described with reference to the accompanying drawings. FIGS. 1 to 5 show an embodiment of the present invention. FIG. 1 is a perspective view of a tray in a state with a cartridge mounted, FIG. 2 is a perspective view of the tray in a state with the cartridge removed, FIG. 3 is a schematic perspective view of the optical disk device. FIGS. 4A to 4C are cross-sectional views showing various states of installation and removal of the tray. FIGS. 5A and 5B show the cartridge, with FIG. 5A being a plan view and FIG. 5B being a front view.

An optical disk device 1 for recording and playback of information on a disk includes an optical disk device main body 10 and a tray 20. In the optical disk device main body 10, as shown in FIG. 3 and FIG. 4C, a motor 12 that rotates a turntable 11, cartridge positioning pins 14, and a chassis 15 to which the motor 12 and the cartridge positioning pins 14 are fixed, are housed in a casing 17.

The tray 20 can select and mount a recording medium from either a cartridge 30 in which a disk 31 is housed or a naked disk (bare disk). The cartridge 30 rotatably houses the disk 31 in a casing 35, constituted by upper and lower walls 32 and 33, and a circumferential side wall 34. As shown in FIG. 5A and FIG. 5B, in this casing 35 a substantially U-shaped thin-walled portion 35a is provided around a thick-walled portion 35b by indenting a front portion and both end portions of the upper wall 32.

The tray 20 is configured such that it can move to a position in the optical disk device main body 10 where recording and playback of the cartridge 30 or a bare disk are possible by loading the tray 20 (recording/playback position), and a position where installation and removal of a recording medium is possible by unloading the tray out of the optical disk device main body 10 (installation/removal position). Also, the tray 20 includes a bottom wall 22 that forms a disk-shaped recess 21 in which a bare disk can be placed and held, and a rear wall 23 provided standing on the rear edge of this bottom wall 22. Because FIGS. 4A to 4C are schematic views illustrating various states of installation and removal of the cartridge 30, the recess 21 is omitted from those drawings.

In the front portion of the bottom wall 22 of the tray 20, a pair of pressing means 25 are provided that support the mounted cartridge 30 from the front. Each of the pressing means 25 is constituted by an oscillating body 28 that can oscillate around a support shaft 26 provided standing on the bottom wall 22 and that has a pressing portion 27 contacting the front face of the cartridge 30, and a biasing means 29 that biases the oscillating body 28 in the direction that the pressing portion 27 presses the cartridge 30. The biasing means 29 is constituted by bar-shaped spring material, one side of which is linked to the oscillating body 28, and the other side of which is linked to the bottom wall 22. Accordingly, when the cartridge 30 has been placed on the bottom wall 22 of the tray 20, the pressing portion 27 presses the cartridge 30 against the rear wall 23.

During recording and playback of the disk 31, the chassis 15 rises, the cartridge positioning pins 14 position the cartridge 30 at a predetermined distance from the cartridge mounting face of the bottom wall 22 of the tray 20, and the housed disk 31 is chucked to the turntable 11 (the turntable 11 is fitted to a hole 31a formed in the center of the disk 31, separating the disk 31 from the casing 17 to rotate the disk 31). Chucking position refers to this sort of state in which the tray 20 is in the recording/playback position and the cartridge 30 is in a position that is a predetermined distance away from the cartridge mounting face of the tray 20

On both sides of the rear wall 23 of the tray 20, latching protrusions 24 that latch to the outer face of a rear angular portion (the upper edge face of a rear angular portion) of the thin-walled portion 35a of the cartridge 30 are provided in the frontward direction by integral molding. On the bottom face (the face facing the cartridge 30) of each latching protrusion 24, an inclined face 24a that inclines upward from the base portion of the protrusion towards the leading edge is formed. The inclined face 24a of each latching protrusion 24 is provided in a position at a height where the rear angular portion of the cartridge 30 does not make contact with the inclined face 24a when the cartridge 30 is in the chucking position. Also, the upper face of each latching protrusion 24 and the upper face of the rear wall 23 are flush with each other.

In the upper portion of the pressing portion 27 of each pressing means 25, a latching protrusion 27a that latches to the outer face of a front angular portion (upper edge face of a front angular portion) of the thin-walled portion 35a of the cartridge 30 is provided in the rearward direction by integral molding. On the bottom face of each latching protrusion 27a, an inclined face 27b that inclines upward from the base portion of the protrusion towards the leading edge is formed. The inclined face 27b is provided in a position at a height where the front angular portion of the cartridge 30 does not make contact with the inclined face 27b when the cartridge 30 is in the chucking position. Also, the upper face of the latching protrusion 27a and the upper face of the pressing portion 27 are flush with each other.

Following is a description of a case in which the optical disk device 1 having the above configuration is used.

First, the tray 20 is positioned in the installation/removal position, and the cartridge 30 is pressed in forward in a state in which the leading edge of the cartridge 30 has been allowed to make contact with the pressing portion 27 of the pressing means 25 (see FIG. 4A). When allowing the leading edge of the cartridge 30 to make contact with the pressing portion 27, the inclined face of the latching protrusion 27a provided in the pressing portion 27 becomes a guide face and slidably guides the leading edge of the cartridge 30, and so the cartridge 30 can be pressed in easily and reliably. The oscillating body 28 oscillates around the support shaft 26 against the elastic force of the biasing means 29.

The near side of the cartridge 30 (rear portion in the direction of insertion) is lowered downward, setting the cartridge 30 by placing it on the cartridge mounting face of the bottom wall 22 of the tray 20. Thus, the cartridge 30 is biased from front to rear by the pressing portion 27, and the rear edge face of the cartridge 30 makes contact with the inner face of the rear wall 23 of the tray 20 (see FIG. 4B).

Moreover, the tray 20 is transported inside the optical disk device main body 10. When the tray 20 has been loaded and is in the recording/playback position, the turntable 11 and the cartridge positioning pins 14 rise up with the chassis 15 from below the tray 20, positioning the cartridge 30 in the chucking position, and the housed disk 31 is chucked by the turntable 11 from below (see FIG. 4C).

In a state in which the disk 31 inside this cartridge 30 has been chucked by the turntable 11, the upper edge face of the front angled portion of the cartridge 30 does not make contact with the inclined face 27b of the pressing means 25, and also, the upper edge face of the rear angled portion of the cartridge 30 does not make contact with the inclined face 24a of the rear wall 23 of the tray 20. Accordingly, when chucking the disk 31, the cartridge 30 does not make contact with the inclined face 24a and shift its position in the front or rear direction, and the disk 31 can be accurately chucked without the respective latching protrusions 24 and 27a becoming obstructions.

When the cartridge 30 is removed from the tray 20, the tray 20 is unloaded and transported to the installation/removal position. Then, when the rear portion of the cartridge 30 is lifted up, the rear top edge angled portion of the cartridge 30 makes contact with the inclined face 24a of the latching protrusion 24 of the rear wall 23, but the cartridge 30 presses against the pressing portion 27 while the rear angled portion slides along the inclined face 24a. Thus, the cartridge 30 can be easily and quickly removed without the latching protrusion 24 becoming an obstruction.

When the optical disk device 1 is used in a vertically placed state, the tray 20 becomes vertically oriented, but because the front and rear angular portions of the cartridge 30 mounted in the tray 20 are respectively latched to the latching protrusions 24 and 27a, the optical disk device 1 is able to hold the cartridge. Accordingly, when loading or unloading the cartridge 30, the cartridge 30 does not drop out from the tray 20 or become jammed between the tray 20 and the casing 17. In addition, because the latching protrusions 24 and 27a are provided by integral molding with the rear wall 23 and the pressing portion 27 of the tray 20, the structure is simple, and in addition, because the latching protrusions 24 and 27a latch the thin-walled portion 35a of the cartridge 30, it is possible to effectively make the tray 20 thinner.

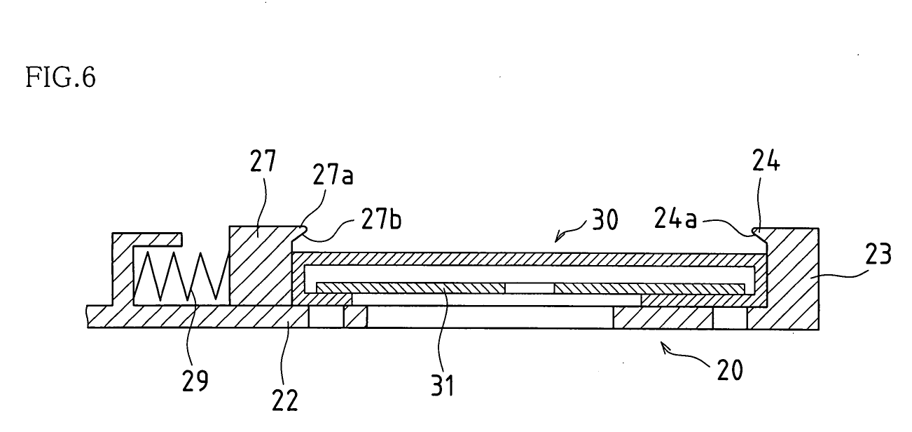

FIGS. 6, 7, 8A, and 8B show other embodiments of the present invention. Members that are the same as in the embodiment described above are given the same reference numerals and their explanation is omitted here. In the embodiment of the present invention shown in FIG. 6, the cartridge 30 is formed with a uniform thickness.

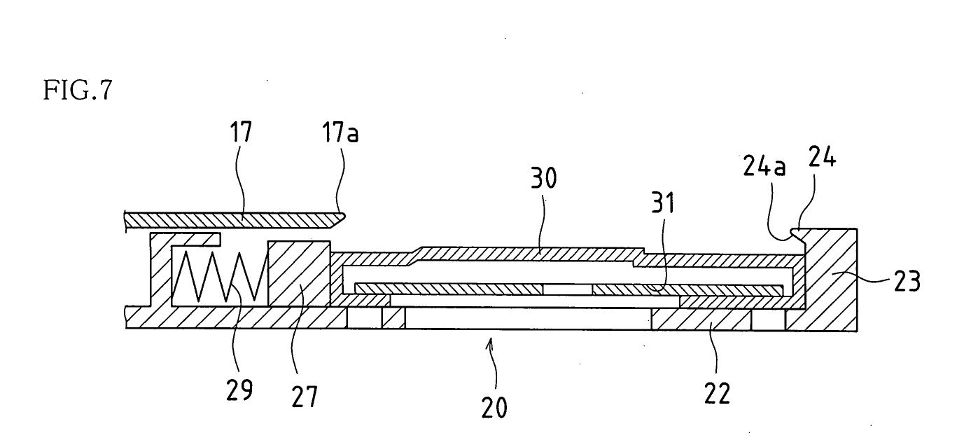

In the embodiment shown in FIG. 7, the latching protrusion 27a is not provided in the pressing portion 27, and an opening marginal portion 17a of the casing 17 provides a function equivalent to that of the latching protrusion 27a.

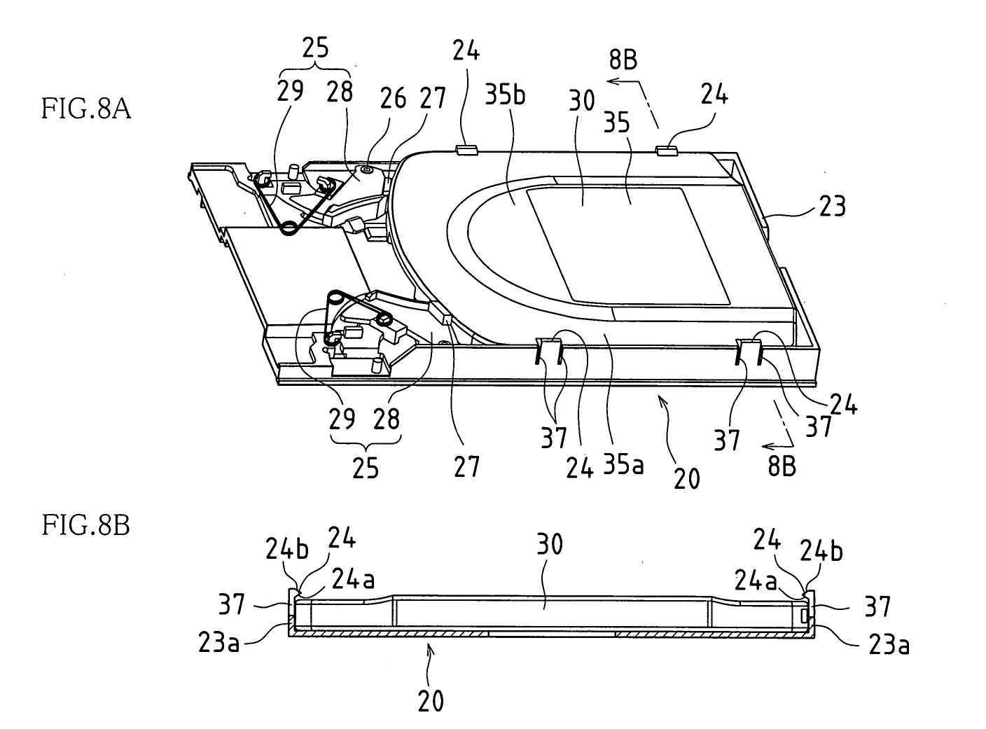

In the other embodiment shown in FIGS. 8A and 8B, the latching protrusions 24 are provided in both side walls 23a of the tray 20, not only the rear wall 23 of the tray 20. By providing the latching protrusions 24 in the side walls 23a with a predetermined space, the cartridge 30 can be stably held. Also, it is preferable to form incisions 37 in the side walls 23a such that the tray 20 can be elastically deformed when installing and removing the cartridge 30 to and from the tray 20.

The upper and lower faces of the latching protrusion 24 are formed as inclined faces 24a and 24b. The upper inclined face 24b becomes the guiding face when mounting the cartridge 30 into the tray 20. When providing a plurality of latching protrusions 24 in the side wall as in the present embodiment, it is not necessary to provide a latching protrusion in the pressing portion 27.

The present invention is not limited to the embodiments described above. In the present embodiments, a case in which the latching protrusions 24 and 27a have been integrally provided with the rear wall 23 and the pressing portion 27 of the tray 20 was given as an example, but they may also be configured from components separate from the tray 20 and the pressing portion 27. Also, a configuration in which it is possible to mount either the cartridge 30 or a bare disk in the tray 20 was given as an example, but a configuration can also be adopted in which it is only possible to mount the cartridge 30.

Additionally, the embodiments described above had a configuration in which the cartridge 30 is separated from the bottom wall 22 of the tray 20 when chucking the disk 31, but a state is also possible in which the cartridge 30 is placed on the bottom wall 22 of the tray 20.

The present invention may be embodied in other forms without departing from the purport or essential characteristics thereof. The embodiments disclosed in this application are to be considered in all respects as illustrative and not limiting. The scope of the invention is indicated by the appended claims rather than by the foregoing description, and all changes that come within the meaning and range of equivalency of the claims are intended to be embraced therein.

What is claimed is:

1. An optical disk device comprising:
a tray in which a cartridge housing a disk is mounted, configured to be transportable to a position where recording and playback are possible by loading the tray into the main body of the optical disk device, and a position where it is possible to install and remove the cartridge by unloading the tray out of the main body of the optical disk device,
wherein latching protrusion(s) is/are provided in the tray that latch(es) an outer face of an angular portion of the cartridge.

2. The optical disk device according to claim 1, wherein the tray is provided with pressing means that press(es) a mounted cartridge from the front towards a rear wall of the tray, and the latching protrusion(s) is/are provided in the rear wall.

3. The optical disk device according to claim 2, wherein the latching protrusion(s) is/are provided in the pressing means.

4. The optical disk device according to claim 2 or 3, wherein inclined face(s) is/are formed in the latching protrusion(s) provided in the rear wall, such that the cartridge can slide when being removed.

5. The optical disk device according to claim 3, wherein inclined face(s) is/are formed in the latching protrusion(s) provided in the pressing means, such that the cartridge can slide when being mounted.

6. The optical disk device according to claim 4, wherein inclined face(s) is/are formed in the latching protrusion(s) provided in the pressing means, such that the cartridge can slide when being mounted.

7. The optical disk device according to claim 4, configured so that the inclined face(s) of the latching protrusion(s) provided in the rear wall does/do not make contact with the cartridge when the tray is in the recording/playback position and the disk in the cartridge has been chucked.

8. The optical disk device according to claim 5, configured so that the inclined face(s) of the latching protrusion(s) provided in the pressing means does/do not make contact with the cartridge when the tray is in the recording/playback position and the disk in the cartridge has been chucked.

9. The optical disk device according to claim 6, configured so that the inclined face(s) of the latching protrusion(s) provided in the pressing means does/do not make contact with the cartridge when the tray is in the recording/playback position and the disk in the cartridge has been chucked.

10. The optical disk device according to any of claims 1 to 3, wherein the cartridge has two or more portions of varying thickness, and the latching protrusion(s) is/are provided in position(s) where the thinner of those portions is latched.

11. The optical disk device according to claim 4, wherein the cartridge has two or more portions of varying thickness, and the latching protrusion(s) is/are provided in position(s) where the thinner of those portions is latched.

12. The optical disk device according to claim 5, wherein the cartridge has two or more portions of varying thickness, and the latching protrusion(s) is/are provided in position(s) where the thinner of those portions is latched.

13. The optical disk device according to claim 6, wherein the cartridge has two or more portions of varying thickness, and the latching protrusion(s) is/are provided in position(s) where the thinner of those portions is latched.

14. The optical disk device according to claim 7, wherein the cartridge has two or more portions of varying thickness, and the latching protrusion(s) is/are provided in position(s) where the thinner of those portions is latched.

15. The optical disk device according to claim 8, wherein the cartridge has two or more portions of varying thickness, and the latching protrusion(s) is/are provided in position(s) where the thinner of those portions is latched.

16. The optical disk device according to claim 9, wherein the cartridge has two or more portions of varying thickness, and the latching protrusion(s) is/are provided in position(s) where the thinner of those portions is latched.
